(19) United States
(12) Patent Application Publication
(10) Pub. No.: US 2017/0151960 A1
(43) Pub. Date: Jun. 1, 2017

(54) APPARATUS FOR ASSISTING RETREAT TRAVELLING FOR VEHICLE AND METHOD FOR THE SAME

(71) Applicant: DENSO CORPORATION, Kariya-city (JP)

(72) Inventors: Koji Fujiki, Kariya-city (JP); Takeshi Miura, Kariya-city (JP); Masuhiro Kondo, Kariya-city (JP); Takahiro Narita, Kariya-city (JP); Hiroaki Ohshima, Kariya-city (JP)

(21) Appl. No.: 15/359,106

(22) Filed: Nov. 22, 2016

(30) Foreign Application Priority Data
Nov. 26, 2015 (JP) 2015-230600

(51) Int. Cl. B60W 50/12; B60W 10/20; B60W 10/08; G05D 1/02; B60W 30/18; B60W 50/14; B60W 30/14; B60W 10/184; B60W 10/30

(52) U.S. Cl. CPC B60W 50/12; B60W 10/184; B60W 10/20; B60W 10/08; B60W 10/30; B60W 30/18009; B60W 50/14; B60W 30/146; G05D 1/021; B60W 2050/146; B60W 2420/52; B60W 2420/42; B60W 2540/26; B60W 2720/106; G05D 2201/0213

(57) ABSTRACT

A retreat traveling assist apparatus is provided with a state detecting module, a traveling command module, and a body command module. The state detecting module detects a state in which a driver of the vehicle cannot drive the vehicle properly (hereinafter referred to as driving-impossible state). The traveling command module activates a retreat travelling deceleration control to stop the vehicle in a refuge place surrounding the vehicle, when the state detecting module detects the driving-impossible state. The body command module activates a pretensioner control to tighten a seatbelt of a driver's seat in the vehicle, in response to an activation of the retreat traveling deceleration control activated by the traveling command module.

### CROSS-REFERENCE TO RELATED APPLICATION

This application is based on and claims the benefit of priority from earlier Japanese Patent Application No. 2015-230600 filed Nov. 26, 2015, the description of which is incorporated herein by reference.

### BACKGROUND

Technical Field

The present disclosure relates to a technique for retreating a vehicle when detecting a state where a driver cannot perform a driving operation properly.

Description of the Related Art

Conventionally, a vehicle control technique used for stopping the vehicle in a safe place has been known. This technique is employed in a case of detecting a decline of consciousness of the vehicle's driver because of sleep or a sudden illness or the like.

For example, JP-A-2007-331652 proposes a technique for changing an orientation of the vehicle by differentiating the amount of braking forces between left and right wheels, in the case where the vehicle is conducted to a target stopping position by a steering control and a brake control, but the steering wheel cannot be controlled because the driver strongly grips the steering wheel.

However, according to the above-mentioned technique, since it is required to use a difference of the braking forces between left and right wheels, instead of a steering operation, the target stopping position may have to be re-set to a position distant from the vehicle. Hence, there is a restriction because the steering operation is unable to be performed. Accordingly, the vehicle may not be stopped promptly in an appropriate refuge place depending on the situation (e.g., traffic or obstacle) around the vehicle.

### SUMMARY

The present disclosure has been achieved in light of the above-described circumstances and to provide a technique in which an appropriate retreat traveling assist can be executed without being disturbed by unintentional behavior of the driver.

A retreat traveling assist apparatus according to one aspect of the present disclosure is provided with a state detecting module, a traveling command module, and a body command module. The state detecting module detects a state in which a driver of the vehicle cannot drive the vehicle properly (hereinafter referred to as driving-impossible state). The traveling command module activates a retreat travelling deceleration control to stop the vehicle in a refuge place surrounding the vehicle, when the state detecting module detects the driving-impossible state. The body command module activates a pretensioner control to tighten a seatbelt of a driver's seat in the vehicle, in response to an activation of the retreat traveling deceleration control activated by the traveling command module.

According to such a configuration, a driver in the driving-impossible state is strongly fixed to a backrest of the seat by the seatbelt, at any timing selected from a time within a certain period before/after the retreat traveling deceleration control starts. Therefore, unnecessary steering operation, accelerator operation and brake operation caused by the driver falling forward the seat can be avoided. Accordingly, since unintentional behavior of the driver can be avoided, appropriate retreat traveling assistance can be prevented from being disturbed.

According to a retreat traveling assist method of one aspect of the present disclosure, a similar effect to the retreat traveling assist apparatus as described above can be obtained.

### BRIEF DESCRIPTION OF DRAWINGS

In the accompanying drawings:

FIG. 1 is a block diagram showing an overall configuration of an on-vehicle system 1;

FIG. 2 is a functional block diagram showing a configuration of a retreat travelling assist unit;

FIG. 3 is a flowchart showing a retreat travelling assist process;

FIG. 4 is a flowchart showing a post release travelling control process; and

FIG. 5 is a diagram showing an on-vehicle system and a driver sitting in a driver's seat in vehicle.

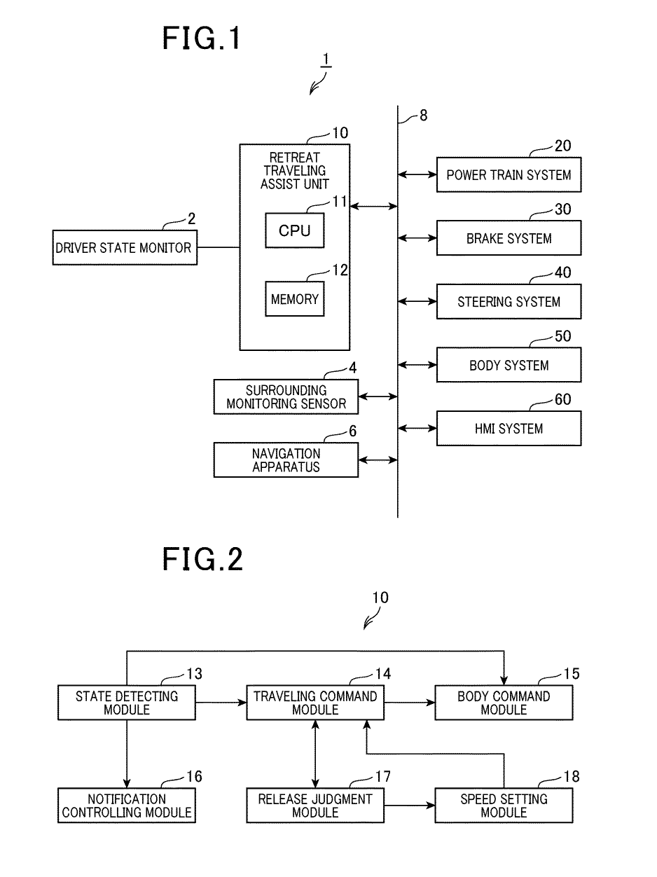

### DETAILED DESCRIPTION OF PREFERRED EMBODIMENTS

Hereinafter, with reference to the drawings, embodiments of the present disclosure will be described.

### First Embodiment

[1.1. An overall configuration]

An on-vehicle system 1 is provided with a driver state monitor 2, a surrounding monitoring sensor 4, a navigation apparatus 6, a vehicle LAN 8, a retreat travelling assist unit 10, a power train system 20, a brake system 30, a steering system 40, a body system 50 and a HMI system 60.

An in-vehicle LAN 8 is a local area network provided in the vehicle. According to the present embodiment, a retreat travelling assist unit 10, a power train system 20, a brake system 30, a steering system 40, a body system 50, and a HMI system 60 are communicably connected to the vehicle LAN 8. In the vehicle LAN 8, vehicle information such as detection values, control values or the like in various controls systems is shared by using one or more communication protocols. As for the communication protocols, well-known protocol is used such as CAN, FlexRay, Lin, MOST, AVC-LAN or the like.

The power train system 20 is provided with an electronic control unit (hereinafter referred to as ECU) which controls a drive source of the vehicle. In normal operation, the ECU of the power train system 20 controls a throttle opening of the throttle apparatus and quantity of the fuel injection when an internal combustion engine is mounted on the vehicle to provide a driving force, in accordance with an accelerator operation amount such as accelerator depression amount or the like, and controls power supplied to a motor when the motor is mounted on the vehicle as a drive source.

The ECU of the power train system 20 performs known cruise control that controls the drive source when it is implemented to the vehicle, to maintain a constant speed set in advance or an inter-vehicle distance in response to the traveling speed. The ECU of the power train system 20 sets a target acceleration factor for maintaining the traveling speed and the inter-vehicle distance, and temporally stops performing the cruise control when detecting an accelerator operation amount which is larger than the accelerator operation amount corresponding to the target acceleration amount, and performs normal control operation.

It should be noted that a predetermined acceleration operation amount is defined as a threshold corresponding to the target acceleration factor which is zero or less. Hereinafter, the acceleration operation amount which is a threshold used for temporally stopping a cruise control is defined as a first operation amount. The first operation amount may be an acceleration operation amount which is a threshold used to release the cruise control.

The ECU of the power train system 20 controls the drive source in accordance with a driving power output commanded by the retreat traveling assist unit 10, when performing a retreat deceleration control or a post-release traveling control, which will be described later. The ECU of the power train system 20 is configured such that the control is resumed to a normal operation mode or a cruise control mode, when a release command indicating a post release traveling control process is received which is transmitted from the retreat traveling assist unit 10.

The brake system 30 is provided with an ECU that controls a brake of the vehicle. The brake system ECU controls, in normal operation, an actuator provided in a hydraulic circuit of a hydraulic brake in accordance with a brake operation amount such as a depression amount or the like of the brake pedal. The brake system 30 may generate a brake force of a regenerative brake by controlling a power supplied to the motor, when the vehicle has a motor as a drive source.

When cruise control is performed, the ECU of the brake system 30 controls the brake, in accordance with a target acceleration factor having negative value (i.e., target deceleration factor) set by the ECU of the power train system 20. Also, the ECU of the brake system 30 controls the brake, when performing retreat deceleration control or a post-release traveling control, which will be described later, in accordance with a braking power output commanded by the retreat traveling assist unit 10. The ECU of the brake system 30 is configured such that the operation is resumed to the brake control of the normal operation or a cruise control, when the ECU receives a release command indicating a post release traveling control process which is transmitted from the retreat traveling assist unit 10.

The steering system 40 is provided with an ECU that controls steering of the vehicle. The ECU of the steering system 40 controls, in a normal operation, a rotational direction and an amount of rotation of a pinion gear disposed in the steering mechanism.

The ECU of the steering system 40 controls the steering, when performing retreat deceleration control which will be described later, in accordance with a steering power output commanded by the retreat traveling assist unit 10.

The body system 50 is provided with an ECU that controls electrical devices as body system parts in the vehicle. In the normal operation, the ECU of the body system 50 controls objects being assigned to respective parts of the body system in accordance with a switching operation or the like.

The control objects includes control of lock/unlock of the vehicle-doors, slide-door, power-window, and open/close of sliding roof, adjusting angle of the rear-view mirror, and height adjusting of the driver's seat.

The ECU of the body system 50 includes an ECU (i.e., seatbelt ECU) which activates a pretensioner (hereinafter referred to as a pretensioner control) to tighten the seatbelt of the driver's seat in the vehicle, when performing a retreat deceleration control which will be described later. The seatbelt ECU activates the pretensioner control in accordance with an operation timing commanded by the retreat traveling assist unit 10. The seatbelt ECU releases the pretensioner to resume a tension of the seat belt to be a regular tension, when a release command of the retreat deceleration control is received, which is transmitted from the retreat traveling assist unit 10.

The HMI system 60 is provided with an ECU which controls electrical devices of a human-machine-interface of the vehicle (hereinafter referred to as HMI). In normal operation, the ECU of the HMI system 60 controls, in accordance with a switching operation or the like, a display apparatus, a sound output apparatus and a wireless communication apparatus, which are disposed in the vehicle.

The ECU of the HMI system 60 performs a voice guidance, a display guidance, a communication to a predetermined emergency contact or the like, in accordance with an operation timing commanded from the retreat traveling assist unit 10. The voice guidance announces a schedule of a retreat traveling deceleration control which will be described later. For example, the voice guidance announces “retreat traveling deceleration control will be performed after 10 seconds” or “retreat traveling deceleration control started” or the like. The display guidance indicates a state of execution of the retreat traveling deceleration control. As display guidance, for example, there are an indication of “performing retreat traveling deceleration control” and an indication of a required time or a distance to stop the vehicle in a refuge place, or the like. The ECU of the HMI system 60 also performs, similar to the retreat traveling deceleration control, the sound guidance or the display guidance for the pretensioner control or the post release traveling control which will be later. In the communication to the emergency contact, for example, emergency instructions including required medical assistance of the driver will be notified to passengers other than the driver via the hotline with an operator.

The driver state monitor 2 is an apparatus for detecting a state of the driver. The state of the driver includes a biological state other than a behavior of the driver. To detect a state of the driver, publicly known methods can be employed, including a method of determining whether or not an abnormal state is present by detecting an opening degree or a motion of the eyelid based on face-image of the driver captured by an image recognition camera, and a method of determining whether or not an abnormal state of vital signs such as blood pressure, heart rate is present, etc., by using an electrode disposed in a seat or a steering wheel.

The surrounding monitoring sensor 4 monitors a surrounding of the vehicle by using cameras or radar devices disposed at e.g., front part, rear part, side part of the vehicle. For example, by using on-vehicle cameras, as is well-known, an edge detection is performed to recognize a lane boundary such as an own vehicle line or an adjacent lane, or a pattern matching is performed to recognize other vehicles, pedestrians, road signs, or the like. By using on-vehicle radar devices, as is well-known, radar waves such as millimeter waves or laser waves are transmitted, and receives reflection waves where the transmitted radar waves are reflected at an object, and then calculates a period from a time when the radar waves are transmitted to a time when the reflected waves are received, thereby obtaining a distance to the object and a relative speed with respect to the own vehicle. Moreover, the on-vehicle radar device detects an azimuth of the object on the basis of incoming direction of the reflection waves. The surrounding monitor sensor 4 detects a shape and a location of the lane boundary line, contents of the road sign, a relative speed and a moving direction of other vehicles and pedestrians, whether or not other vehicles or pedestrians are present, a state of surrounding the vehicle, by using such well-known configurations.

The navigation apparatus 6 acquires a current location of the own vehicle using an arrival time of the electromagnetic waves from satellites of the global-positioning system (hereinafter referred to as GPS) or the like. The navigation apparatus 6 is provided with a map database (hereinafter referred to as map DB) including road map information correlated to the positional information of latitude and altitude. The road map information is a database having a table format in which link information of links that constitute a road and a node connecting between links are correlated with each other. Since the link information includes a link length, a width, a connection node, curve information or the like, a shape of the road can be detected by using the road map information. It should be noted that additional information such as type of road, the number of traffic lanes, speed limit, location of refuge place where the vehicle can be emergency parked, are included in the map DB.

The navigation apparatus 6 extracts road map information from the map DB based on the current location of the vehicle, generates drawing information based on the road map information, and adds icons or the like showing a mark indicating a current location of the own vehicle, various facilities, registered names on the drawing information, and display them on a display apparatus. Once the destination information is received by a switching operation or the like, the navigation apparatus 6 searches a route from the current location to the destination, highlights the route in the drawing information, generates sound information which is outputted from an audio output device, so as to conduct the passenger to the destination.

The navigation apparatus 6 accumulates a traveling direction detected by a gyro sensor and a traveling distance detected by a vehicle speed sensor and adds them into the current location data detected by the GPS, thereby accurately detecting the current location of the vehicle. As a result, a route and distance to the refuge place in the forward direction from the location of the own vehicle on the link, and arriving time can be accurately calculated. Furthermore, in the case where the vehicle runs on a road having a plurality of traffic lanes in the same running direction, for example, a driving lane (i.e., own traffic lane) in the traffic lanes can be identified where the vehicle is located. Thus, the information detected by the navigation apparatus 6 about the own traffic lane, the location of the road, the speed limit, the location of the refuge place is outputted to the retreat traveling assist unit 10 in timely manner.

[1-2 configuration of retreat traveling assist unit 10]

The retreat traveling assist unit 10 is an ECU mainly configured of a known microcomputer having CPU 11 and a semiconductor memory (hereinafter referred to as memory 12) such as RAM, ROM, a flash memory, and a communication controller for the vehicle LAN 8. In the retreat traveling assist unit 10, the CPU 11 executes various processes based on a program stored in the memory 12, so as to execute a method corresponding to the program. It should be noted that one or more microcomputers may be used in the retreat traveling assist unit 10, and each of the microcomputers can be disposed at any portion in the vehicle.

The retreat traveling assist unit 10 is provided with, as shown FIG. 2, a state detecting module 13, a traveling command module 14, a body command module 15, a notification controlling module 16, a release judgment module 17 and a speed setting module 18, as a functional configuration achieved by executing the various processes by the CPU 11. A part of these functions or all of functions provided by the retreat traveling assist unit 10 can be configured by hardware such as one or more logical circuit blocks or one or more electronic circuit blocks which may be accomplished by an integrated circuit (i.e. IC). In other words, according to the retreat traveling assist unit 10, the above-described functions can be provided by not only software but also hardware or combinations of these.

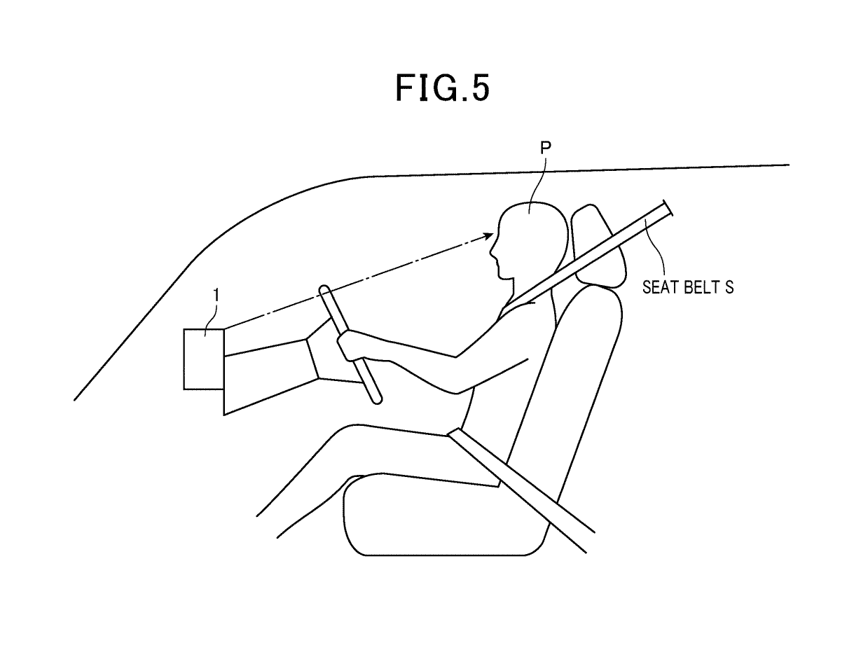

The state detecting module 13 detects a state where the driver of the vehicle cannot drive the vehicle properly as a driving-impossible state. The driving-impossible state is not defined based on a driving skill of the driver, but defined as a state where the driver cannot drive the vehicle properly because of physiological reason of the driver such as sleep or an ill health. Specifically, the driving-impossible state is determined by a degree of abnormality concerning a state of the driver, based on a detection result of the driver state monitor 2. For example, as shown in FIG. 5, assuming the driver P in a driver's seat is in driving-impossible state, the driving-impossible state is detected when the eyelid of the driver is closed for a predetermined time or blood pressure or heart rate is larger than a predetermined threshold. Also, the state detecting unit 1 3 detects a driving-impossible state when a switch is turned on by the driver who determines himself or herself as being in a driving-impossible state. Moreover, in the case where the driver determines by himself or herself changing the state from a driving-impossible state to a driving-possible state (hereinafter referred to as driving-restoration state), and turns the switch ON, the state detecting module 13 may detect the driving-restoration state.

The traveling command module 14 activates a retreat travelling deceleration control, when the state detecting module 13 detects the driving-impossible state, so as to stop the vehicle in an appropriate refuge place considering a surrounding of the vehicle. The refuge place allows the vehicle to park safely, for example, including at a turnout, an emergency parking area, and a road shoulder. According to the present embodiment, information about these refuge places is transmitted from a navigation apparatus 6.

The traveling command module 14 selects, from the information of the refuge places transmitted from the navigation apparatus, an appropriate refuge place considering the surroundings of the vehicle, based on the detection result of the surrounding monitoring sensor 4. The appropriate refuge place is selected as a place in a location as close as possible to the own vehicle and minimizing the effect on the other vehicles and pedestrians, for performing the retreat deceleration control. In more detail, in the selected refuge place, a target position is set for stopping the vehicle (target stop position). The retreat deceleration control conducts the vehicle to the target stop position from the current location to stop the vehicle at the target stop position.

Specifically, the traveling command module 14 acquires a travelling route from the current location of the own vehicle to the target stop position, from the navigation apparatus 6. The traveling command module 14 generates, based on the detection result of the surrounding monitoring sensor 4, a travelling locus where a prescribed position (e.g., center position of the vehicle) of the vehicle draws along the acquired travelling route. The traveling command module 14 is configured such that the driving power output, the braking power output and steering power output are calculated so as to allow the vehicle to run along the generated traveling locus and stop at the target stop position, and the calculated result is transmitted to the vehicle LAN 8. In the travelling command module 14, functions corresponding to calculations of the driving power output, the braking power output and the steering power output may be transferred to ECUs corresponding to the power train system 20, the brake system 30 and the steering system 40 respectively.

When the state detecting module 13 detects a driving-impossible state, the body command module 15 activates the pretensioner control, in response to an activation of the retreat traveling deceleration control by the traveling command module 14, so as to tighten the seatbelt S of the driver's seat (shown in FIG. 5). Specifically, the body command module 15 transmits a command to the vehicle LAN 8, indicating a predetermined operation timing selected from a time within a certain period before/after the retreat traveling deceleration control starts, whereby the body system 50 starts performing the pretensioner control. The operation timing may be before starting the retreat traveling deceleration control or may be after the retreat travelling deceleration control has started, or may be at the same time as a time when the retreat traveling deceleration control starts. The function of the body command module 15 may be transferred to the ECU of the body system 50.

When the state detecting module 13 detects a driving-impossible state, the notification controlling module 16 notifies the passenger about an execution of at least one of the retreat travelling deceleration control or the pretensioner control. Specifically, the notification controlling module 16 transmits a command to the vehicle LAN 8, indicating a predetermined operation timing selected from a time within a certain period before/after the retreat traveling deceleration control starts or a pretensioner control starts, whereby the HMI system 60 performs voice guidance or a display guidance. The operation timing is set for both the retreat traveling deceleration timing and the pretensioner timing, and may be before each of the control, or may be after each of the control, or may be the same time as a time when each of the controls starts. Also, the notification controlling module 16 may notify the passenger about a post release traveling control or a speed limit control which will be described later, similar to the retreat traveling deceleration control or the pretensioner control. The function of the notification controlling module 16 may be transferred to the ECU of the HMI system 60.

The release judgment module 17 judges, based on an accelerator operation amount of the vehicle, whether or not the retreat traveling deceleration control being executed is released, the retreat traveling deceleration control being activated by the traveling command module 14. Specifically, the release judgment module 17 releases the retreat travelling deceleration control being executed, when detecting the accelerator operation amount which is larger than or equal to a second operation amount set in advance as a value larger than a first operation amount used in a cruise control. The second operation amount is set to 90, when the first operation amount is set to 20, for example. This is because, the retreat traveling deceleration control is not released unless the driver shows stronger will of the release, compared to a case of a temporal stop of the cruise control. It should be noted that the second operation amount may be set by the release judgment module 17 or may be a fixed value. When the state detecting module 13 detects a driving-restoration state, the retreat traveling deceleration control being executed may be released.

The speed setting module 18 sets, based on the speed limit of the road where the vehicle runs, an upper speed limit in the post release traveling control. The post release traveling control controls an acceleration responding to the accelerator operation amount of the vehicle to be smaller than that in a normal driving state, when the release judgment module 17 releases the retreat traveling deceleration control being executed. In other word, after releasing the retreat traveling deceleration control, when the vehicle runs for a predetermined period or a predetermined distance, the driver may still be in a driving-impossible state. In this respect, the vehicle is controlled to be difficult to accelerate and the upper speed limit is set just to be on the safe side. It should be noted that the upper speed limit may be set based on the speed set in the cruise control. For example, the upper speed limit may be set such that a predetermined amount is subtracted from the above-described speed limit or the speed set in the cruise control.

Specifically, the speed setting module 18 selects either a speed limit transmitted from the navigation system 6, or a speed limit which is set based on the content of the road sign recognized by the surrounding monitoring sensor 4, and sets the selected speed limit or a speed lower than the selected speed limit to be the upper speed limit. The upper speed limit being set is transmitted to, for example, the power train system 20 and the brake system 30, thereby performing the drive control and the brake control of the vehicle not to exceed the upper speed limit of the traveling speed. These drive control and brake control are referred to as a traveling speed limit control.

[1-3 process]

[1-3-1. Retreat Traveling Assist Process]

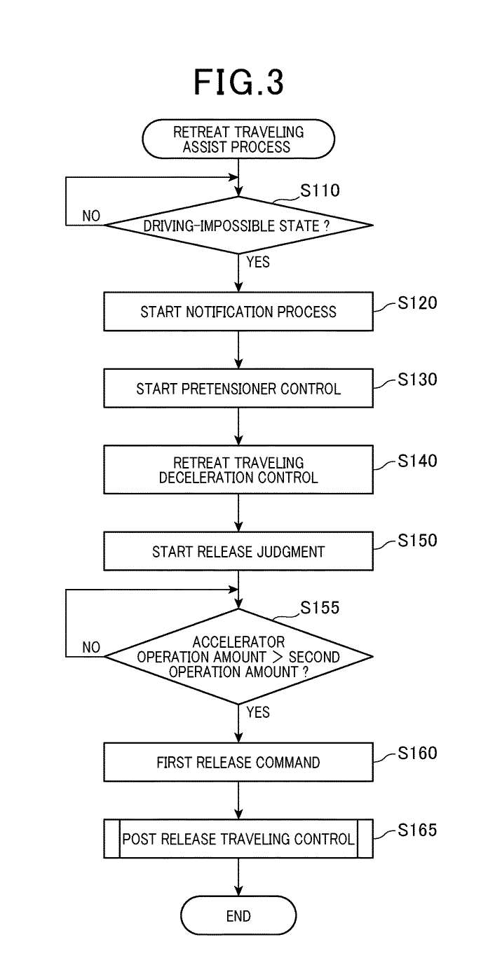

Next, a process executed by the retreat travelling assist unit 10 (hereinafter referred to as retreat travelling assist process) will be described with reference to a flowchart shown in FIG. 3. For example, the process is repeatedly activated at every predetermined cycle, while the ignition switch of the vehicle is being turned ON.

When the process is activated, the state detecting module 13 determines whether or not a driving-impossible state is present at step S110. When the driving-impossible state is detected, the process moves to S120, and when the driving-impossible state is not detected, the process repeats step S110.

In S120, the notification controlling module 16 starts a notification process about the retreat travelling assist. In this case, passenger in the vehicle is notified that the retreat traveling deceleration control and the pretensioner control has been activated. For example, a notification “Detected driving-impossible state of driver, To ensure safety of the driver, automatic traveling will be activated to retreat vehicle to safe place, and seatbelt will be wound up” is performed.

Subsequently, in S130, the body command module 15 starts to execute the pretensioner control. Thus, the driver in the driving-impossible state is strongly fixed to a backrest of the seat by the seatbelt.

At S140, the traveling command module 14 generates a travelling locus to a target stop position from the current location of the own vehicle, calculates a driving power output, a braking power output and a steering power output, and transmits the calculation result to the vehicle LAN 8, such that the vehicle decelerates along the generated traveling locus to stop at the target stop position. In other word, retreat traveling deceleration control is activated. In S140, the notification controlling module 16 may enable the navigation apparatus 6 to perform a route guidance including route, distance and arriving time to a target stop position.

Next, at S150, the release judgment module 17 starts a release judgment which compares the accelerator operation amount acquired from the accelerator pedal opening sensor (not shown) with the second operation amount. At S155, the release judgment module 17 determines release of the retreat traveling deceleration control, when a result of the release judgment at S150 is that the accelerator operation amount is larger than the second operation amount, and proceeds to S160. Also, at S155, the release judgment module 17 determines continuation of the retreat traveling deceleration control, when a result of the release judgment at S150 is that the accelerator operation amount is smaller than the second operation amount, and repeats the process of S155.

At S160, the traveling command module 14 transmits a release command (hereinafter referred to as first release command) of the retreat deceleration control to the vehicle LAN 8, so as to have the ECU of the body system 50 release the pretensioner control. It should be noted that normal steering control is resumed when the ECU of the steering system 40 receives the first release command.

At subsequent step S165, the traveling command module 14 starts to execute the post-release traveling control, and terminates the process. At S165, the notification controlling module 16 may notify the passenger of a release of the retreat deceleration control and an activation of the post-release traveling control.

[1-3-2. Post-release Traveling Control Process]

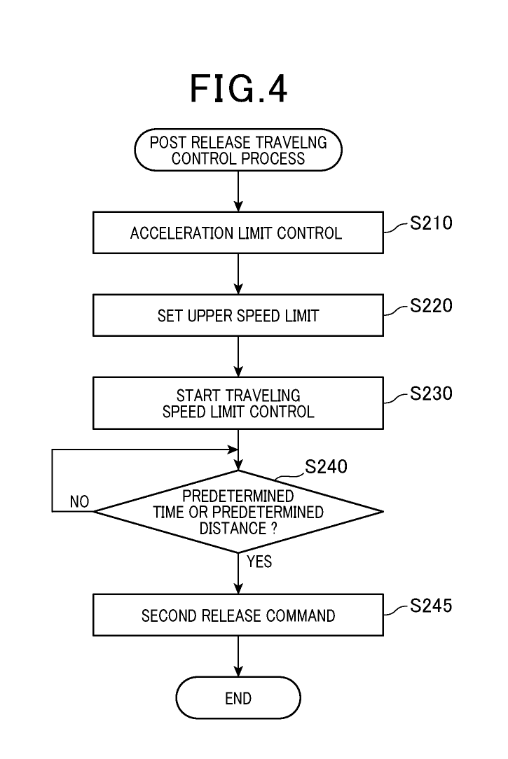

Next, with reference to a flowchart shown in FIG. 4, a post-release traveling control process executed by the CPU11 at S165 will be described.

At S210, the traveling command module 14 starts to execute, as the post-release traveling control, a traveling control (hereinafter referred to as acceleration limit control) in which an acceleration responding to the accelerator operation amount of the vehicle is smaller than that of a normal driving state. In the acceleration limit control, for example, when assuming the acceleration factor of the vehicle corresponding to 1 accelerator operation amount in the normal operation is 100, the acceleration factor of the vehicle corresponding to 1 accelerator operation amount in the post-release traveling control is set to be 90. The driving power output thus calculated is transmitted to the vehicle LAN 8 from the traveling command module 14, and received by the ECU in the power train system 20.

At S220, the speed setting module 18 sets the upper speed limit based on the speed limit of the road where the vehicle runs. For example, the upper speed limit is set to be lower than the speed limit to secure a predetermined safety margin. Specifically, the upper speed limit is set to 80 when the speed limit is 100. The upper speed limit is thus set and transmitted to the traveling command module 14, for example. Then, the driving power output and the braking power output based on the upper speed limit are transmitted to the vehicle LAN 8 from the traveling command module 14, and received by the power train system 20 and the brake system 30. The upper speed limit may be the speed limit itself. The upper speed limit is not limited to a speed set based on the speed limit. Alternatively, the upper speed limit may be set based on a setting speed of the cruise control or may be a predetermined fixed value. At S230, the traveling command module 14 compares the own traveling speed acquired by a vehicle speed sensor (not shown) with the upper speed limit, allowing the vehicle to accelerate responding to an accelerator operation amount in the vehicle, within a range where the traveling speed of the own vehicle is the upper speed limit or less. Specifically, the travelling command module 14 estimates the traveling speed of the own vehicle after the acceleration, on the basis of the acceleration factor calculated at S210 and the traveling speed of the own vehicle before the acceleration, the acceleration factor calculated at S210 corresponding to an accelerator operation amount acquired by the accelerator pedal opening sensor or the like. The traveling command module 14 compares the estimated traveling speed of the own vehicle with the upper speed limit. When the estimated traveling speed of the own vehicle is larger than the upper speed limit, a driving power output and a braking power output which are set based on the upper speed limit are transmitted to the vehicle LAN 8, and when the estimated traveling speed of the own vehicle is smaller than or equal to the upper speed limit, the driving power output and the braking power output calculated at S210 are transmitted to the vehicle LAN 8. Thus, the traveling speed limit control is started.

At subsequent S240, the traveling command module 14 determines whether or not a predetermined time laps from a time when the first release command is activated at S160, or whether or not the vehicle runs for a predetermined distance. Here, when the predetermined time elapses or the vehicle runs for a predetermined distance, the process moves to S240, and when the predetermined time has not elapsed or the vehicle has not run for a predetermined distance, the present step is repeated. At S245, the traveling command module 14 transmits a release command of the post release traveling control (hereinafter referred to as a second release command) to the vehicle LAN 8. When the power train system 20 and the brake system 30 receive the second release command, the control is resumed to a control for the normal operation or the cruise control.

[1-4. Effects]

According to the above-described first embodiment, the folio wing effects can be obtained.

(1a) Driver fallen in the driving-impossible state is strongly fixed to a backrest of the seat by the seatbelt, at any timing selected from a time within a certain period before/after the retreat traveling deceleration control starts. Therefore, unnecessary steering operation, accelerator operation and brake operation caused by the driver falling forward in the seat is avoided. Accordingly, since unintentional behavior of the driver can be avoided, appropriate retreat traveling assist can be prevented from being disturbed.

(2a) Release timing of the retreat traveling deceleration control being executed, which is activated by the traveling command module 14, can be determined based on the accelerator operation amount in the vehicle. Accordingly, when the state of the driver is resumed to normal in which the driver is able to perform a driving operation properly (hereinafter referred to as driving possible state), the driver can perform driving operation normally, whereby the vehicle control can be resumed smoothly to a regular traveling control.

(3a) Retreat traveling deceleration control is released when the accelerator operation amount larger than or equal to the second operation amount is detected, the second operation amount being set in advance as an accelerator operation amount larger than the first operation amount. In other word, a threshold of the accelerator operation amount for temporarily stopping the retreat traveling deceleration control is larger than that of a threshold of the acceleration operation amount for releasing the cruise control. Therefore, compared to a case of releasing the cruise control, since the retreat traveling deceleration control is released only when the driver shows strong will to release it, miss-releasing of the retreat traveling deceleration control due to miss-operation of the driver can be avoided.

(4a) When the retreat traveling deceleration control being executed is released by the release judgment module 17, the post-release traveling control is activated so as to control the acceleration responding to the accelerator operation amount in the vehicle to be smaller than that of the normal driving state. After releasing the retreat traveling deceleration control, when the vehicle runs for a predetermined period or a predetermined distance, the driver may still be in a driving-impossible state. In this respect, the vehicle can be controlled to be difficult to accelerate just to be on the safe side.

(5a) Specifically, in the post-release traveling control, acceleration of the vehicle responding to an accelerator operation amount is enabled within a range where the traveling speed of the own vehicle is the upper speed limit or less. As a result, the vehicle can run safely and reliably.

(6a) Moreover, in the post-release traveling control, the upper speed limit is set based on the speed limit of the road where the vehicle runs, thereby contributing safety driving appropriate for running environment of the vehicle.

(7a) When the state detecting module 13 detects a driving-impossible state, the passenger is notified of an execution of at least one of the retreat travelling deceleration control or the pretensioner control. Accordingly, it is possible to prompt the driver not to perform unnecessary operation such as steering operation, accelerator operation and braking operation, or to notify the driver of performing such a control in advance. As a result, the vehicle can be retreated safely.

[2. Other Embodiment]

As described, embodiments of the present invention have been described. However, the present invention is not limited to the above-described embodiments, and these embodiments can be modified in various ways to be implemented to the present invention.

(2A) According to the above-described embodiments, the retreat traveling deceleration control is releases when the accelerator operation amount exceeds the second operation amount. However, the configuration is not limited thereto. For example, the retreat traveling deceleration control may not be performed if the accelerator operation amount exceeds a predetermined upper value, even when the accelerator operation amount exceeds the second operation amount. The upper limit value mentioned here is larger than the second operation amount, and is set in advance in order to avoid erroneous release of the retreat traveling deceleration control due to miss-operation by the driver.

(2B) A plurality of functions included in a single element of the above-described embodiments may be achieved by a plurality of elements, or one function included in a single element may be achieved by a plurality of elements. A plurality of functions included in a plurality of elements may be achieved by a single element, or a function achieved by a plurality of elements may be achieved by a single element. Also, a part of configurations of the above-described embodiments can be omitted. At least part of the above-described configuration may be added to other configuration of the above-described embodiments, or may replace other configuration of the above-described embodiments. It should be noted that various aspects inherent in the technical ideas identified by the scope of claims are defined as embodiments of the present disclosure.

(2C) Other than the above-described retreat traveling assist unit 10, the present invention can be achieved in various modes such as the on-vehicle system 1 including the retreat traveling assist unit 10 as an element, one or more programs having a computer serve as the retreat traveling assist unit 10 or the on-vehicle system, one or more non-transitional substantive recording medium such as semiconductor memory devices which store at least part of the programs, or a retreat traveling assist method.

What is claimed is:

1. A retreat traveling assist apparatus mounted to a vehicle, assisting retreat travelling of the vehicle, the apparatus comprising:
a state detecting module that detects a driving-impossible state in which a driver of the vehicle cannot drive the vehicle properly;
a traveling command module that activates a retreat travelling deceleration control to stop the vehicle in a refuge place surrounding the vehicle, when the state detecting module detects the driving-impossible state; and
a body command module that activates a pretensioner control to tighten a seatbelt of a driver's seat in the vehicle, in response to an activation of the retreat traveling deceleration control activated by the traveling command module.

2. The retreat traveling assist apparatus according to claim 1, wherein
the apparatus further comprises a release judgment module that judges, based on an accelerator operation amount of the vehicle, whether or not the retreat traveling deceleration control being executed is released.

3. The retreat traveling assist apparatus according to claim 2, wherein
a first operation amount is defined as an acceleration operation amount used to release a cruise control being executed in the vehicle, and a second operation amount is set in advance, as an acceleration operation amount larger than the first operation amount; and
the release judgment module is configured to release the retreat travelling deceleration control currently being executed, when the acceleration operation amount larger than or equal to the second operation amount is detected.

4. The retreat traveling assist apparatus according to claim 2, wherein
the traveling command module performs a post release traveling control, when the release judgment module releases the retreat traveling deceleration control being executed, the post release traveling control controlling an acceleration responding to an accelerator operation amount of the vehicle to be smaller than that in a normal driving state.

5. The retreat traveling assist apparatus according to claim 4, wherein
a upper speed limit is set in advance, limiting a traveling speed of the vehicle; and
the post-release traveling control enables acceleration of the vehicle responding to an accelerator operation amount within a range where the traveling speed is the upper speed limit or less.

6. The retreat traveling assist apparatus according to claim 5, wherein
the apparatus further comprises a speed setting module that sets the upper speed limit based on a speed limit of a road where the vehicle runs.

7. The retreat traveling assist apparatus according to claim 1, wherein
the apparatus further comprises a notification controlling module that notifies a passenger in the vehicle, when the state detecting module detects the driving-impossible state, about an execution of at least one of the retreat travelling deceleration control or the pretensioner control.

8. A method of retreat traveling assist of a vehicle comprising:
a state detecting step that detects a driving-impossible state in which a driver of the vehicle cannot drive the vehicle properly;
a traveling command step that activates a retreat travelling deceleration control to stop the vehicle in a refuge place surrounding the vehicle, when the state detecting module detects the driving-impossible state; and
a body command step that activates a pretensioner control to tighten a seatbelt of a driver's seat in the vehicle, in response to an activation of the retreat traveling deceleration control activated by the traveling command module.

9. A method of retreat traveling assist of a vehicle comprising steps of:
detecting a driving-impossible state in which a driver of the vehicle cannot drive the vehicle properly;
activating a retreat traveling deceleration control when the driving-impossible state is detected, the retreat traveling deceleration control stopping the vehicle in a refuge place surrounding the vehicle; and
activating a pretensioner control to tighten a seatbelt of a driver's seat in the vehicle, in response to the activation of the retreat traveling deceleration control.
